(19) United States
(12) Patent Application Publication
(10) Pub. No.: US 2022/0108174 A1
(43) Pub. Date: Apr. 7, 2022

(54) TRAINING NEURAL NETWORKS USING AUXILIARY TASK UPDATE DECOMPOSITION

(71) Applicant: Google LLC, Mountain View, CA (US)

(72) Inventors: Yann Dauphin, Accra (GH); David Grangier, Mountain View, CA (US); Lucio Dery, Pittsburgh, PA (US)

(21) Appl. No.: 17/491,953

(22) Filed: Oct. 1, 2021

Related U.S. Application Data
(60) Provisional application No. 63/087,013, filed on Oct. 2, 2020.

(51) Int. Cl. G06N 3/08; G06K 9/62

(52) U.S. Cl. CPC G06N 3/08; G06K 9/6262; G06K 9/6232

(57) ABSTRACT

Methods, systems, and apparatus, including computer programs encoded on a computer storage medium, for training a neural network having a plurality of model parameters to perform a main task. In one aspect, a method comprises: determining an auxiliary task update to the model parameters of the neural network that, if applied to the model parameters, is predicted to increase a performance of the neural network on an auxiliary task; determining a decomposition of the auxiliary task update into multiple constituent updates that, if applied to the model parameters, are each predicted to have a different impact on a performance of the neural network on the main task; determining a new auxiliary task update to the model parameters of the neural network as a function of the plurality of constituent updates; and applying the new auxiliary task update to the model parameters of the neural network.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations for training a neural network having a set of model parameters to perform a main task.

According to a first aspect there is provided a method performed by one or more data processing apparatus for training a neural network having a plurality of model parameters to perform a main task, the method comprising: determining an auxiliary task update to the model parameters of the neural network that, if applied to the model parameters of the neural network, is predicted to increase a performance of the neural network on an auxiliary task; determining a decomposition of the auxiliary task update into a plurality of constituent updates that, if applied to the model parameters of the neural network, are each predicted to have a different impact on a performance of the neural network on the main task; determining a new auxiliary task update to the model parameters of the neural network as a function of the plurality of constituent updates; and applying the new auxiliary task update to the model parameters of the neural network.

In some implementations, the plurality of constituent updates comprise a beneficial update that, if applied to the model parameters of the neural network, is predicted to increase a performance of the neural network on the main task.

In some implementations, the plurality of constituent updates comprise a detrimental update that, if applied to the model parameters of the neural network, is predicted to decrease a performance of the neural network on the main task.

In some implementations, the plurality of constituent updates comprise a neutral update that, if applied to the model parameters of the neural network, is predicted to have a neutral effect on a performance of the neural network on the main task.

In some implementations, determining the decomposition of the auxiliary task update comprises: obtaining a plurality of main task gradients, wherein each main task gradient is a gradient of a main task objective function with respect to the model parameters of the neural network; and determining the decomposition of the auxiliary task update using the plurality of main task gradients.

In some implementations, determining the decomposition of the auxiliary task update using the plurality of main task gradients comprises: identifying a main task subspace based on the plurality of main task gradients, comprising determining a set of basis vectors that span the main task subspace; determining a main task update to the model parameters of the neural network as a combination of the plurality of main task gradients; and determining the decomposition of the auxiliary task update using: (i) the main task subspace, and (ii) the main task update.

In some implementations, the main task subspace is a lower-dimensional approximation of a span of the plurality of main task gradients.

In some implementations, determining the set of basis vectors that span the main task subspace comprises: performing an approximate singular value decomposition of a matrix defined by the plurality of main task gradients to determine a set of singular vectors of the matrix; and identifying a plurality of the singular vectors of the matrix as the set of basis vectors that span the main task subspace.

In some implementations, determining the main task update to the model parameters of the neural network as a combination of the plurality of main task gradients comprises: determining the main task update to the model parameters of the neural network as an average of the plurality of main task gradients.

In some implementations, determining the decomposition of the auxiliary task update using: (i) the main task subspace, and (ii) the main task update, comprises: determining, for each basis vector in the set of basis vectors spanning the main task subspace, whether an agreement criterion between the auxiliary task update and the main task update is satisfied with respect to the basis vector; determining the beneficial update to be a projection of the auxiliary task update onto the basis vectors for which the agreement criterion between the auxiliary task update and the main task update is satisfied; and determining the detrimental update to be a projection of the auxiliary task update onto the basis vectors for which the agreement criterion between the auxiliary task update and the main task update is not satisfied.

In some implementations, the agreement criterion between the auxiliary task update and the main task update is satisfied with respect to a basis vector if a dot product of the auxiliary task update with the basis vector has a same sign as a dot product of the main task update with the basis vector.

In some implementations, determining the decomposition of the auxiliary task update using: (i) the main task subspace, and (ii) the main task update, comprises: determining the neutral update to be a portion of the auxiliary task update that is orthogonal to the main task subspace.

In some implementations, determining a new auxiliary task update to the model parameters of the neural network as a function of the beneficial update, the detrimental update, and the neutral update, comprises: scaling the beneficial update, the detrimental update, and the neutral update by respective scaling factors; and determining the new auxiliary task update based on a linear combination of the scaled beneficial update, the scaled detrimental update, and the scaled neutral update.

In some implementations, scaling the beneficial update, the detrimental update, and the neutral update by respective scaling factors comprises: scaling the beneficial update and the detrimental update by respective scaling factors having opposite signs.

In some implementations, the scaling factor that scales the beneficial update has a larger magnitude than the respective scaling factors that the detrimental update and the neutral update.

In some implementations, the method further comprises: determining a main task update to the model parameters of the neural network that, if applied to the model parameters of the neural network, is predicted to increase a performance of the neural network on the main task; and applying the main task update to the model parameters of the neural network.

In some implementations, determining an auxiliary task update to the model parameters of the neural network comprises: determining a plurality of auxiliary task gradients, wherein each auxiliary task gradient is a gradient of an auxiliary task objective function with respect to the model parameters of the neural network; and determining the auxiliary task update as a combination of the plurality of auxiliary task gradients.

In some implementations, the method further comprises using the neural network to perform the main task after the neural network has been trained to perform the main task.

Particular embodiments of the subject matter described in this specification can be implemented so as to realize one or more of the following advantages.

The system described in this specification can train a neural network to perform one or more auxiliary tasks as part of training the neural network to perform a main task. Learning to perform the auxiliary tasks can enable the neural network to learn more effective internal representations of network inputs, and thereby improve the performance (e.g., prediction accuracy) of the neural network on the main task.

To train the neural network to perform an auxiliary task, the system determines an auxiliary task update to the model parameters of the neural network that is predicted to increase the performance of the neural network on the auxiliary task. Rather than directly applying the auxiliary task update to the model parameters of the neural network, the system decomposes the auxiliary task update into respective updates that are predicted to be beneficial, detrimental, or neutral to the performance of the neural network on the main task. The system can then weight the respective parts of the auxiliary task update differently depending on their predicted impact on the performance of the neural network on the main task, e.g., to enhance the impact of beneficial parts of the auxiliary task update. The system can thereby train the neural network to a higher level of performance (e.g., prediction accuracy) on the main task than neural networks trained using conventional approaches. In some cases, the system can train the neural network to achieve an acceptable level of performance on the main task over fewer training iterations than would be required by conventional training techniques, thus reducing consumption of computational resources (e.g., memory and computing power) during training.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example training system.

FIG. 2 is a flow diagram of an example process for training a neural network to perform a main task.

FIG. 3 is a flow diagram of an example process for determining a decomposition of an auxiliary task update.

FIG. 4 illustrates example decompositions of a main task update, an auxiliary task update, and a new auxiliary task update.

Like reference numbers and designations in the various drawings indicate like elements.

### DETAILED DESCRIPTION

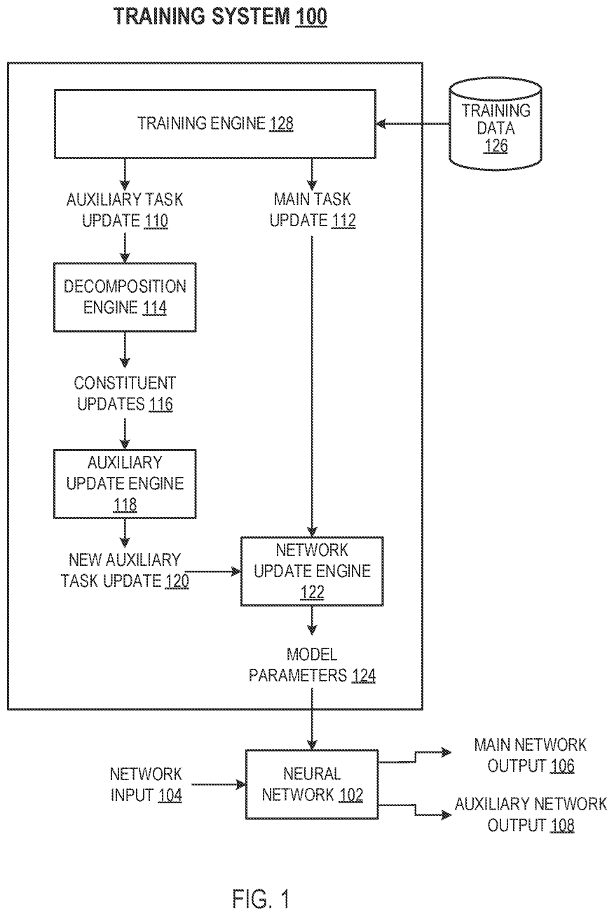

FIG. 1 shows an example training system 100. The training system 100 is an example of a system implemented as computer programs on one or more computers in one or more locations in which the systems, components, and techniques described below are implemented.

The training system 100 trains a neural network 102 to perform one or more auxiliary tasks as a part of training the neural network 102 to perform a main task.

In particular, the training system 100 can train the neural network 102 to process a network input 104 to generate: (i) a main network output 106 characterizing the network input 104, (ii) one or more auxiliary network outputs (e.g., auxiliary network output 108) that each characterize the network input 104, or (iii) both. The training system 100 can train the neural network 102 to perform the main task by updating model parameters 124 of the neural network 102 using “main task updates” (e.g., main task update 112). As part of training the neural network 102 to perform the main task, the training system 100 can train the neural network 102 to perform the one or more auxiliary tasks by updating the model parameters 124 of the neural network 102 using a respective “auxiliary task update” for each of the one or more auxiliary tasks (e.g., auxiliary task update 110). Generally, the main task update is predicted to improve the performance of the neural network on the main task, while each auxiliary task update is predicted to improve the performance of the neural network on a respective auxiliary task. Generating main task updates and auxiliary task updates, and using them to update the model parameters of the neural network 102, will be described in more detail below.

The neural network 102 can have any appropriate neural network architecture that enables it to perform its described function, i.e., processing a network input to generate a main network output, and optionally, one or more auxiliary network outputs. In particular, the neural network can include any appropriate types of neural network layers (e.g., fully-connected layers, attention-layers, convolutional layers, etc.) in any appropriate numbers (e.g., 1 layer, 5 layers, or 25 layers), and connected in any appropriate configuration.

In a particular example, the neural network can generate each auxiliary network output by processing an intermediate output of the neural network using one or more respective “auxiliary” neural network layers to generate the auxiliary network output. Optionally, since the auxiliary tasks are used to facilitate training the neural network to perform the main task, the auxiliary neural network layers used to generate the auxiliary outputs can be removed after the neural network has been trained.

The system described herein is widely applicable and is not limited to one specific implementation. However, for illustrative purposes, a small number of example implementations are described below.

The main task and the auxiliary task(s) can be any appropriate machine learning tasks. In particular, the main task and the auxiliary task(s) may include processing any kind of digital data input to generate any kind of score, classification, or regression output based on the input.

In some implementations, the network input 104 can include image data, sound data, textual data, lidar data, radar data, hyperspectral data, or a combination thereof.

For example, the main task can include classifying the network input 104 into a main set of classes (e.g., represented by main network output 106), and the one or more auxiliary tasks can include classifying the network input 104 into respective auxiliary sets of classes (e.g., represented by auxiliary network output 108).

In another example, the main task can include processing the network input 104 to generate a main regression output (e.g., represented by main network output 106), and the one or more auxiliary tasks can include processing the network input 104 to generate respective auxiliary regression outputs (e.g., represented by auxiliary network output 108).

In some cases, the main task and the auxiliary task(s) can be image processing tasks, e.g., processing an input image to generate respective network outputs for the input image. For example, the main task and/or the auxiliary task(s) can be an image classification task, e.g., processing an image to generate scores for each object category in a set of object categories, with each score representing a likelihood that the image shows an object belonging to the category. As another example, the main task and/or the auxiliary task(s) can be an image embedding generation task, e.g., processing an image to generate a numeric embedding of the image. As another example, the main task and/or the auxiliary task(s) can be an object detection task, e.g., processing an image to generate data identifying locations in the image at which particular types of objects are shown. As another example, the main task and/or the auxiliary task(s) can be an image segmentation task, e.g., processing an image to generate respective outputs that each assigns each pixel of the image to a category from a set of categories. As another example, the main task and auxiliary task(s) can be a medical image processing task, e.g., processing a medical image to generate a respective score for each medical condition in a set of medical conditions, where the score for each medical condition defines a likelihood that the image shows tissue affected by the medical condition.

In some cases, the main task and the auxiliary task(s) can be processing network inputs 104 that characterize Internet resources (e.g., web pages), documents, or portions of documents or features extracted from Internet resources, documents, or portions of documents, e.g., to classify the resource or document. A classification of a given Internet resource, document, or portion of a document can include a score for each of a set of topics, with each score representing an estimated likelihood that the Internet resource, document, or document portion is about the topic.

In some cases, the main task and the auxiliary task(s) can be processing network inputs 104 that include features of an impression context for a particular advertisement, e.g., to generate a score that represents an estimated likelihood that the particular advertisement will be clicked on.

In some cases, the main task and the auxiliary task(s) can be processing features of a personalized recommendation for a user (e.g., features characterizing the context for the recommendation, e.g., features characterizing previous actions taken by the user), e.g., to generate a score for each of a set of content items. Each score can represent an estimated likelihood that the user will respond favorably to being recommended the content item.

In some cases, the main task and the auxiliary task(s) can be processing a sequence of text in one language, e.g., to generate a score for each of a set of pieces of text in another language. Each score can represent an estimated likelihood that the piece of text in the other language is a proper translation of the input text into the other language.

In some cases, the main task and the auxiliary task(s) can be audio processing tasks. For example, the main task or auxiliary task(s) can be processing a sequence representing a spoken utterance to generate a score for each of a set of pieces of text. Each score can represent an estimated likelihood that the piece of text is the correct transcript for the utterance. As another example, the main task or the auxiliary task(s) can be a keyword spotting task, e.g., processing a sequence representing a spoken utterance to generate an output indicating whether a particular word or phrase (“hotword”) was spoken in the utterance. As another example, the main task or the auxiliary task(s) can be processing a sequence representing a spoken utterance to identify the natural language in which the utterance was spoken.

In some cases, the main task and the auxiliary task(s) can be a natural language processing or understanding task, e.g., an entailment task, a paraphrase task, a textual similarity task, a sentiment task, a sentence completion task, a grammaticality task, and so on, that operates on a sequence of text in some natural language.

In some cases, the main task and the auxiliary task(s) can be text processing tasks, e.g., a text to speech task, e.g., processing text in a natural language or features of text in a natural language to generate a spectrogram or other data defining audio of the text being spoken in the natural language.

In some cases, the main task and the auxiliary task(s) can be health prediction tasks, e.g., processing electronic health record data for a patient to generate a prediction that is relevant to the future health of the patient, e.g., a predicted treatment that should be prescribed to the patient, the likelihood that an adverse health event will occur to the patient, or a predicted diagnosis for the patient.

In some cases, the main task can be an agent control task, e.g., processing an observation characterizing a state of an environment being interacted with by an agent to generate an output that defines an action to be performed by the agent. The agent can be, e.g., a real-world robot, a simulated robot, or a control system for an industrial facility.

The training system 100 trains the neural network 102 over a sequence of training iterations on a set of training data 126. The set of training data 126 can include multiple main task training examples and multiple auxiliary task training examples. Main task training examples each include a network input and a respective target main network output. Auxiliary task training examples for a particular auxiliary task each include a network input (e.g., the same network input as a respective main task training example) and a respective target auxiliary network output corresponding to the particular auxiliary task. That is, the set of training data includes multiple network inputs (e.g., network input 104) and for each network input (1) a respective target main network output (e.g., main network output 106) and/or (2) a respective auxiliary network output for each auxiliary task (e.g., auxiliary network output 108). For convenience, the training system 100 is described in the following as training the neural network 102 to perform a single auxiliary task to facilitate training the neural network 102 to perform the main task.

At each training iteration, the training system 100 can determine a main task update 112, an auxiliary task update 110, or both to facilitate training the neural network 102 at each training iteration using a training engine 128.

The training engine 128 can determine the main task update 112 from multiple main task gradients. Each main task gradient can be a gradient of a main task objective function with respect to the model parameters 124 of the neural network 102. The training engine 128 can process a network input from a main task training example using the neural network to generate a main task output. Then, the training engine 128 can compute the gradients of the main task objective function (e.g., that depends on the main task output) with respect to the model parameters of the neural network (e.g., using backpropagation).

The training engine 128 can determine the auxiliary task update 110 from multiple auxiliary task gradients. Each auxiliary task gradient can be a gradient of an auxiliary task objective function with respect to the model parameters 124 of the neural network 102. The training engine 128 can process a network input from an auxiliary task training example using the neural network to generate an auxiliary task output. Then, the training engine 128 can compute the gradients of the auxiliary task objective function (e.g., that depends on the auxiliary task output) with respect to the model parameters of the neural network (e.g., using backpropagation).

Generally, the main task objective function and the auxiliary task objective function can be any appropriate objective functions. For example, if the main task or the auxiliary task is a classification task, then the corresponding objective function can be, e.g., a cross-entropy objective function. As another example, if the main task or the auxiliary task is a regression task, then the corresponding objective function can be, e.g., a squared-error objective function.

The training engine 128 can determine the main task update 112 as a function of the main task gradients. For example, the system can determine the main task update 112 as an average of the main task gradients.

The training engine 128 can determine the auxiliary task update 110 as a function of the auxiliary task gradients. For example, the system can determine the auxiliary task update 110 as an average of the auxiliary task gradients.

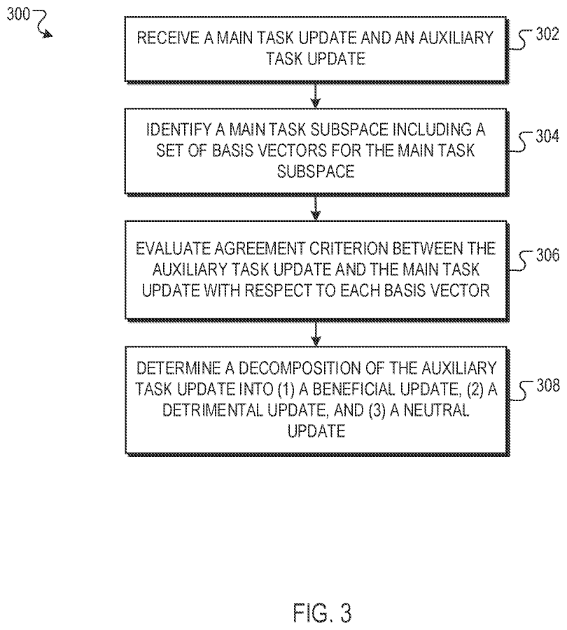

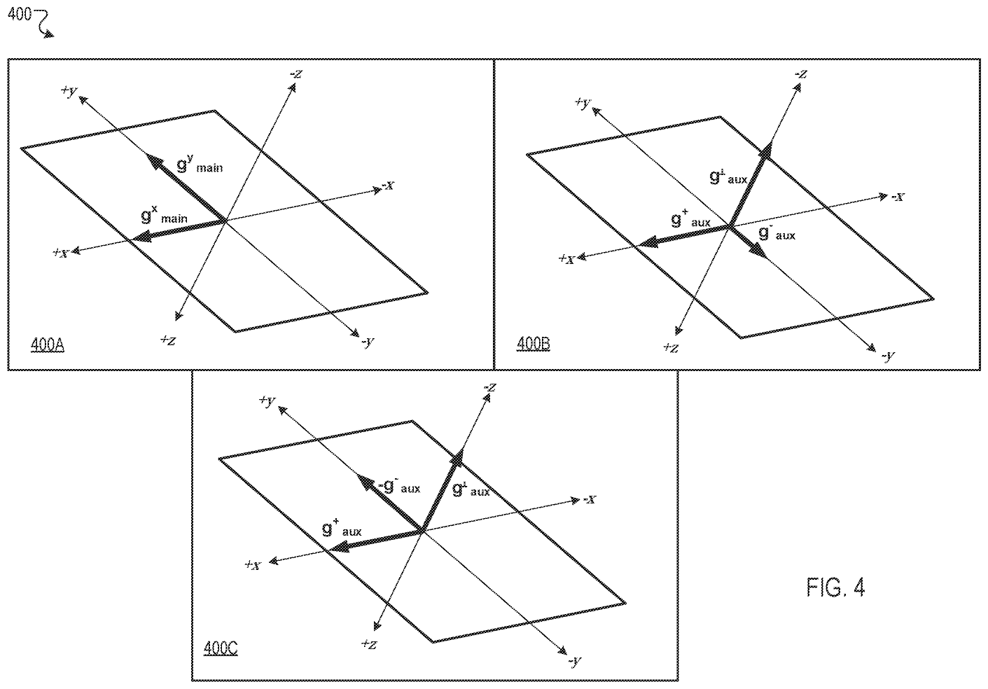

At each training iteration, the training system 100 can generate constituent updates 116 by processing the auxiliary task update 110 using a decomposition engine 114. The decomposition engine 114 can decompose the auxiliary task update 110 into constituent updates 116 that are each predicted to have a different impact on a performance of the neural network performing the main task. Additionally, the constituent updates 116, if summed, yield the auxiliary task update 110. For example, the decomposition engine 114 can decompose the auxiliary task update 110 into a beneficial update (e.g., an update that, if applied to the model parameters of the neural network, is predicted to increase a performance of the neural network on the main task), a detrimental update (e.g., an update that, if applied to the model parameters of the neural network, is predicted to decrease a performance of the neural network on the main task), and a neutral update (e.g., an update that, if applied to the model parameters of the neural network, is predicted to have a neutral effect on a performance of the neural network on the main task), as is described with reference to FIG. 3. Example decompositions are illustrated with reference to FIG. 4.

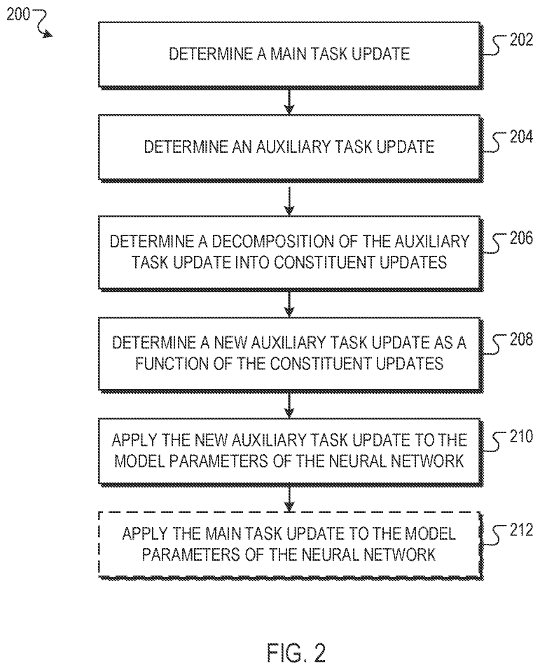

At each training iteration, the training system 100 generates a new auxiliary task update 120 from the constituent updates 116. The new auxiliary task update 120 is an update that is predicted to have a greater beneficial impact on a performance of the neural network on the main task than the auxiliary task update 110. The training system 100 generates the new auxiliary task update 120 by processing the constituent updates 116 using an auxiliary update engine 118. The auxiliary update engine 118 can generate the new auxiliary task update 120 as a function of the constituent updates 116. For example, the auxiliary update engine 118 can determine the new auxiliary task update 120 as a linear combination of the constituent updates 116 using a set of scaling factors (e.g., having values that are selected to enhance the effect of the beneficial update, or reduce or reverse the effect of the detrimental update), as is described with reference to FIG. 2.

At each training iteration, the training system 100 can apply the new auxiliary task update 120 and optionally the main task update 112 to the model parameters 124 of the neural network 102 using a network update engine 122. The network update engine 122 can apply only the new auxiliary task update 120, only the main task update 112, or a function of the new auxiliary task update 120 and the main task update 112 to the model parameters 122 using any appropriate optimization method. For example, the network update engine 120 can apply a linear combination of the new auxiliary task update 120 and the main task update 112 (e.g., using equal weights, unequal weights, or setting one weight to zero to apply only one of either the main task update or the new auxiliary task update) to the model parameters 124 using an appropriate gradient descent optimization technique, e.g., RMSprop or Adam. Optionally, at certain training iterations, the training system 100 can apply only the new auxiliary task update 120, or only the main task update 112. In a particular example, the training system 100 can pre-train the neural network by applying only new auxiliary task updates, and then fine-tune the model parameters of the neural network by applying only main task updates. In this example, the system can still determine the main task updates during pre-training for use in decomposing the auxiliary task updates to determine the new auxiliary task updates.

Optionally, after training, the neural network can cease performing the auxiliary task (e.g., in implementations where the auxiliary network output is generated by one or more auxiliary neural network layers, the one or more auxiliary neural network layers can be removed). The system trains the neural network over a sequence of training iterations to perform the auxiliary task as part of training the neural network to perform the main task using the new auxiliary task updates and the main task updates. The auxiliary task updates are modified at each training iteration to enhance their effect upon improving the performance of the neural network on the main task. That is, the system trains the neural network to perform the auxiliary tasks in order to improve the neural network's performance on the main task. Learning to perform the auxiliary task can enable the neural network to learn more effective internal representations of network inputs, and thereby improve the performance (e.g., prediction accuracy) of the neural network on the main task.

FIG. 2 is a flow diagram of an example process for training a neural network. For convenience, the process 200 will be described as being performed by a system of one or more computers located in one or more locations. For example, a training system, e.g., the training system 100 of FIG. 1, appropriately programmed in accordance with this specification, can perform the process 200.

The system can perform the steps (202)-(210) at each of multiple training iterations.

The system determines a main task update (202). The system can determine the main task update as a function of multiple main task gradients. Each main task gradient can be a gradient of a main task objective function with respect to the model parameters of the neural network. For example, if the main task is a classification task, the main task objective function can be, e.g., a cross-entropy objective function. If the main task is a regression task, the main task objective function can be, e.g., a squared-loss objective function or L1 objective function. In a particular example, the system can determine the main task update as a linear combination (e.g., an average) of the main task gradients.

The system determines an auxiliary task update (204). The system can determine an auxiliary task update as a function of multiple auxiliary task gradients. Each auxiliary task gradient can be a gradient of an auxiliary task objective function with respect to the model parameters of the neural network. For example, if the auxiliary task is a classification task, the auxiliary task objective function can be, e.g., a cross-entropy objective function. If the auxiliary task is a regression task, the auxiliary task objective function can be, e.g., a squared-loss objective function or L1 objective function. In a particular example, the system can determine the auxiliary task update as a linear combination (e.g., an average) of the auxiliary task gradients.

The system determines a decomposition of the auxiliary task update into constituent updates (206). Each constituent update, if applied to the model parameters of the neural network, is predicted to have a different impact on a performance of the neural network on the main task. For example, the system can decompose the auxiliary task update into a beneficial update (e.g., that is predicted to increase a performance of the neural network on the main task), detrimental update (e.g., that is predicted to decrease a performance of the neural network on the main task), and neutral update (e.g., that is expected to have a neutral effect on a performance of the neural network on the main task), as is described with reference to FIG. 3. Example decompositions are illustrated with reference to FIG. 4.

The system determines a new auxiliary task update as a function of the constituent updates (208). The system can obtain a respective scaling factor for each constituent update, and determine the new auxiliary task update as a linear combination of the constituent updates. The respective scaling factors can be determined as hyper-parameters using data-driven or heuristic methods. For example, for constituent updates including a beneficial update, a detrimental update, and a neutral update, the respective scaling factors can include a beneficial scaling factor for the beneficial update, a detrimental scaling factor for the detrimental update, and a neutral scaling factor for the neutral update. The respective scaling factors can be represented by (a, b, c), where a, b, and c are real numbers.

In some implementations, the beneficial scaling factor can have an opposite sign from the detrimental scaling factor (e.g., to reverse the effect of the detrimental update from decreasing a performance of the neural network on the main task to increasing the performance of the neural network on the main task).

For example, the scaling factors can be (a, −a, b) for the beneficial factor, detrimental factor, and neutral factor, respectively, where a and b are non-zero, real numbers. In a particular example, the scaling factors can be (1.0, −1.0, 0.5).

In another example, the beneficial scaling factor can have a larger magnitude than detrimental scaling factor and the neutral scaling factor (e.g., to enhance the effects of the beneficial update on the performance of the neural network on the main task). For example, the scaling factors can be (a, −0.5a, 0.5a), respectively, where a is a non-zero, real number. In a particular example, the scaling factors can be (1.0, −0.5, 0.5).

In some implementations, the beneficial scaling factor can be non-zero, e.g., having value 1.0, with the detrimental scaling factor and neutral scaling factor both equal to zero, which can encourage the new auxiliary task update to be purely beneficial for training the neural network to perform the main task. In a particular example, the system can pre-train the neural network to perform the main task using only the auxiliary task update (i.e., no main task update) and scaling factors (1.0, 0.0, 0.0) for the beneficial, detrimental, and neutral scaling factors, respectively. The system can then fine-tune the neural network using only the main task update (i.e., no auxiliary task update).

In some implementations, the beneficial scaling factor and neutral scaling factor can be equal, and the detrimental scaling factor can be zero, to ensure that there is no conflict between the main task update and the new auxiliary task update. Additionally, using a non-zero neutral scaling factor can encourage exploration of the parameter space and thereby increase performance on the main task. Generally, this can be represented by scaling factors (a, 0.0, b) for the beneficial, detrimental, and neutral scaling factors, respectively. In a particular example, the scaling factors can be (1.0, 0.0, 1.0).

The system applies the new auxiliary task update to the model parameters of the neural network (210). The system can apply the new auxiliary task update using an appropriate gradient descent optimization technique, e.g., RMSprop or Adam.

The system optionally applies the main task update to the model parameters of the neural network (212). The system can apply the main task update using an appropriate gradient descent optimization technique, e.g., RMSprop, or Adam. For example, the system can conduct pre-training by applying only the new auxiliary task update (e.g., while still determining the main task update for use in decomposing the auxiliary task update) and not the main task update. Then, the system can conduct fine-tuning by applying only the main task update to the model parameters of the neural network. In another example, the system can apply a function (e.g., a linear combination) of the main task update and the new auxiliary task update to the model parameters of the neural network, instead of applying them separately to the model parameters of the neural network.

FIG. 3 is a flow diagram of an example process for decomposing an auxiliary task update. For convenience, the process 300 will be described as being performed by a system of one or more computers located in one or more locations. For example, a decomposition engine, e.g., the decomposition engine 110 of FIG. 1, appropriately programmed in accordance with this specification, can perform the process 300.

The system receives a main task update and an auxiliary task update (302). The main task update can be determined as a function (e.g., an average) of multiple main task gradients, where each main task gradient is a gradient of a main task objective function. The auxiliary task update can be determined as a function (e.g., an average) of multiple auxiliary task gradients, where each auxiliary task gradient is a gradient of an auxiliary task objective function with respect to the model parameters of the neural network.

The system uses a set of main task gradients to determine a subspace, referred to as a “main task” subspace, of a space of possible gradients (304). To determine the main task subspace, the system can determine a set of basis vectors that span the main task subspace (e.g., such that the main task subspace is defined as the span of the set of basis vectors). The span of a set of vectors refers to the set of all possible linear combinations of the vectors. In some implementations, the main task subspace can be the span of the set of main task gradients. In some implementations, the main task subspace can be a lower-dimensional approximation of the span of the set of main task gradients. The set of main task gradients can be, e.g., the set of main task gradients used to generate the main task update at the current iteration, or a set of main task gradients from a previous training iteration.

The system can identify the main task subspace, e.g., by performing a singular value decomposition of a matrix defined by the main task gradients to determine a set of singular vectors of the matrix. Then, the system can select multiple of the singular vectors of the matrix as the set of basis vectors that span the main task subspace. In some implementations, where the main task subspace can be the span of the set of main task gradients, the system can select all of the singular vectors of the matrix as the set of basis vectors that span the main task subspace. In some implementations, where the main task subspace is a lower-dimensional approximation of the span of the set of main task gradients, the system can select a proper subset of the singular vectors of the matrix to define the main task subspace. For example, the subset can include the k largest singular vectors from the set of singular vectors, where k is a positive integer less than the total number of singular vectors. Singular value decomposition and approximations of singular value decomposition are described in more detail with reference to: Yuji Nakatsukasa, “Accuracy of singular vectors obtained by projection-based SVD methods,” BIT Numerical Mathematics, 57(4):1137-1152, 2017, which is incorporated herein by reference.

The system can determine a new main task subspace at every training iteration, or according to a schedule. The system can use main task gradients that were computed at a previous training iteration to compute the main task subspace at the current training iteration. For example, the system can determine a new main task subspace every N training iterations to enable a more stable training and to reduce consumption of computational resources, e.g., memory and computing power.

The system evaluates an agreement criterion between the auxiliary task update and the main task update with respect to each basis vector of the main task subspace (306). That is, for each basis vector, the system evaluates an agreement criterion between the auxiliary task update and the main task update. For example, the agreement criterion can be that the sign of a dot product between the auxiliary task update and the basis vector is the same as the sign of a dot product between the main task update and the basis vector. The system can evaluate the agreement criterion with respect to each basis vector.

The system determines a decomposition of the auxiliary task update into (1) a beneficial update, (2) a detrimental update, and (3) a neutral update (308). The beneficial update, if applied to the model parameters of the neural network, can be an update predicted to improve a performance of the neural network on the main task. The detrimental update, if applied to the model parameters of the neural network, can be an update predicted to decrease a performance of the neural network on the main task. The neutral update, if applied to the model parameters of the neural network, can be an update predicted to have a neutral impact on a performance of the neural network on the main task. Example decompositions can be seen in FIG. 4.

The system can decompose the auxiliary task update into the beneficial update, detrimental update, and neutral update based on the agreement criteria. For example, the beneficial update can be a “beneficial projection” of the auxiliary task update onto the basis vectors for which the respective agreement criterion between the auxiliary task update and the main task update is satisfied. The system can determine the beneficial projection by computing a respective beneficial basis vector projection of the auxiliary task update along each basis vector for which the respective agreement criterion is satisfied, and summing the respective beneficial basis vector projections of the auxiliary task update. Each beneficial basis vector projection of the auxiliary task update can be computed by determining the dot product between the auxiliary task update and the respective basis vector, and multiplying the result of the dot product by the respective basis vector.

The detrimental update can be a “detrimental projection” of the auxiliary task update onto the basis vectors for which the respective agreement criterion between the auxiliary task update and the main task update is not satisfied. The system can determine the detrimental projection by computing a respective detrimental basis vector projection of the auxiliary task update along each basis vector for which the respective agreement criterion is not satisfied, and summing the respective detrimental basis vector projections of the auxiliary task update. Each detrimental basis vector projection of the auxiliary task update can be computed by determining the dot product between the auxiliary task update and the respective basis vector, and multiplying the result of the dot product by the respective basis vector.

The neutral update can be a portion of the auxiliary task update that is orthogonal to the main task subspace. That is, the neutral update can be a projection of the auxiliary task update onto a remainder of the span of the main task gradients not covered by the basis vectors of the main task subspace. The neutral update can be determined as the result of subtracting the beneficial update and the detrimental update from the auxiliary update.

In a particular example, the beneficial update can be a projection of the auxiliary task update onto the basis vectors for which the sign of a dot product between the auxiliary task update and the basis vector is the same as the sign of a dot product between the main task update and the basis vector. The detrimental update can be a projection of the auxiliary task update onto the basis vectors for which the sign of the two dot products is opposite, and the neutral update can be the portion of the auxiliary task update orthogonal to the main task subspace (e.g., determined as the result of subtracting the beneficial update and detrimental update from the auxiliary task update). Decomposing the auxiliary task update into respective updates that are predicted to be beneficial, detrimental, or neutral to the performance of the neural network on the main task can enable the system to weight the respective parts of the auxiliary task update differently. The weighting can depend on their predicted impact on the performance of the neural network on the main task, e.g., to enhance the impact of beneficial parts of the auxiliary task update. The system can thereby train the neural network to a higher level of performance (e.g., prediction accuracy) on the main task than neural networks trained using conventional approaches. In some cases, the system can train the neural network to achieve an acceptable level of performance on the main task over fewer training iterations, thus reducing consumption of computational resources (e.g., memory and computing power) during training.

FIG. 4 illustrates example decompositions of a main task update, an auxiliary task update, and a new auxiliary task update. The example decompositions are generated by a training system, e.g., the training system 100 of FIG. 1. The new auxiliary task update illustrated with reference to FIG. 4 can be applied to the parameters of a neural network as part of training the neural network to perform a main task.

The example decomposition of 400A shows a main task subspace spanned by basis vectors x and y. The main task subspace can be, e.g., a lower-dimensional approximation of a span of multiple main task gradients. A main task update gₘₐᵢₙ is decomposed into two orthogonal components g^{x}ₘₐᵢₙ and g^{y}ₘₐᵢₙ, along basis vectors x and y, respectively. A third vector, z, represents a direction orthogonal to the main task subspace.

The example decomposition of 400B shows an auxiliary task update decomposed into constituent updates, including a beneficial update g⁺ₐᵤₓ, a detrimental update g⁻ₐᵤₓ, and a neutral update g^{⊥}ₐᵤₓ. The beneficial update g⁺ₐᵤₓ includes components of the auxiliary task update which are predicted to increase a performance of a neural network on a main task (e.g., those components which point in a same direction as the main task update with respect to the basis vectors, such as basis vector x in this example). The detrimental update g⁻ₐᵤₓ includes components of the auxiliary task update which are predicted to decrease a performance of the neural network on the main task (e.g., those components which point in an opposite direction from the main task update with respect to the basis vectors, such as basis vector y in this example). The neutral update g^{⊥}ₐᵤₓ includes components of the auxiliary task update which are predicted to have a neutral effect upon a performance of the neural network on the main task (e.g., those components which point in an orthogonal direction, e.g., z in this example, to the main task subspace, such as the subspace defined by basis vectors x and y in this example).

The example decomposition of 400C shows the decomposition of a new auxiliary task update, including the beneficial update g⁺ₐᵤₓ, an adjusted version of the detrimental update g⁻ₐᵤₓ, and the neutral update g^{⊥}ₐᵤₓ of 400B. The new auxiliary task update can be a function of the constituent updates of 400B, e.g., a linear combination of the constituent updates. In this particular example, the new auxiliary task update can be a linear combination of the beneficial update, detrimental update, and neutral update with scaling factors (1.0, −1.0, 1.0), respectively. That is, the new auxiliary task update can include the beneficial update and neutral update unadjusted, and the negative of the detrimental update, as shown in the figure. The negative of the detrimental update should increase a performance of the neural network on the main task due to being aligned with the direction of one or more components of the main task update (e.g., g^{y}ₘₐᵢₙ, or the component along the y basis vector, in this example).

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more data processing apparatus for training a neural network having a plurality of model parameters to perform a main task, the method comprising:
determining an auxiliary task update to the model parameters of the neural network that, if applied to the model parameters of the neural network, is predicted to increase a performance of the neural network on an auxiliary task;
determining a decomposition of the auxiliary task update into a plurality of constituent updates that, if applied to the model parameters of the neural network, are each predicted to have a different impact on a performance of the neural network on the main task;
determining a new auxiliary task update to the model parameters of the neural network as a function of the plurality of constituent updates; and
applying the new auxiliary task update to the model parameters of the neural network.

2. The method of claim 1, wherein the plurality of constituent updates comprise a beneficial update that, if applied to the model parameters of the neural network, is predicted to increase a performance of the neural network on the main task.

3. The method of claim 2, wherein the plurality of constituent updates comprise a detrimental update that, if applied to the model parameters of the neural network, is predicted to decrease a performance of the neural network on the main task.

4. The method of claim 3, wherein the plurality of constituent updates comprise a neutral update that, if applied to the model parameters of the neural network, is predicted to have a neutral effect on a performance of the neural network on the main task.

5. The method of claim 4, wherein determining the decomposition of the auxiliary task update comprises:
obtaining a plurality of main task gradients, wherein each main task gradient is a gradient of a main task objective function with respect to the model parameters of the neural network; and
determining the decomposition of the auxiliary task update using the plurality of main task gradients.

6. The method of claim 5, wherein determining the decomposition of the auxiliary task update using the plurality of main task gradients comprises:
identifying a main task subspace based on the plurality of main task gradients, comprising determining a set of basis vectors that span the main task subspace;
determining a main task update to the model parameters of the neural network as a combination of the plurality of main task gradients; and
determining the decomposition of the auxiliary task update using: (i) the main task subspace, and (ii) the main task update.

7. The method of claim 6, wherein the main task subspace is a lower-dimensional approximation of a span of the plurality of main task gradients.

8. The method of claim 7, wherein determining the set of basis vectors that span the main task subspace comprises:
performing an approximate singular value decomposition of a matrix defined by the plurality of main task gradients to determine a set of singular vectors of the matrix; and
identifying a plurality of the singular vectors of the matrix as the set of basis vectors that span the main task subspace.

9. The method of claim 6, wherein determining the main task update to the model parameters of the neural network as a combination of the plurality of main task gradients comprises:
determining the main task update to the model parameters of the neural network as an average of the plurality of main task gradients.

10. The method of claim 6, wherein determining the decomposition of the auxiliary task update using: (i) the main task subspace, and (ii) the main task update, comprises:
determining, for each basis vector in the set of basis vectors spanning the main task subspace, whether an agreement criterion between the auxiliary task update and the main task update is satisfied with respect to the basis vector;
determining the beneficial update to be a projection of the auxiliary task update onto the basis vectors for which the agreement criterion between the auxiliary task update and the main task update is satisfied; and
determining the detrimental update to be a projection of the auxiliary task update onto the basis vectors for which the agreement criterion between the auxiliary task update and the main task update is not satisfied.

11. The method of claim 10, wherein the agreement criterion between the auxiliary task update and the main task update is satisfied with respect to a basis vector if a dot product of the auxiliary task update with the basis vector has a same sign as a dot product of the main task update with the basis vector.

12. The method of claim 6, wherein determining the decomposition of the auxiliary task update using: (i) the main task subspace, and (ii) the main task update, comprises:
determining the neutral update to be a portion of the auxiliary task update that is orthogonal to the main task subspace.

13. The method of claim 4, wherein determining a new auxiliary task update to the model parameters of the neural network as a function of the beneficial update, the detrimental update, and the neutral update, comprises:
scaling the beneficial update, the detrimental update, and the neutral update by respective scaling factors; and
determining the new auxiliary task update based on a linear combination of the scaled beneficial update, the scaled detrimental update, and the scaled neutral update.

14. The method of claim 13, wherein scaling the beneficial update, the detrimental update, and the neutral update by respective scaling factors comprises:
scaling the beneficial update and the detrimental update by respective scaling factors having opposite signs.

15. The method of claim 13, wherein the scaling factor that scales the beneficial update has a larger magnitude than the respective scaling factors that the detrimental update and the neutral update.

16. The method of claim 1, further comprising:
determining a main task update to the model parameters of the neural network that, if applied to the model parameters of the neural network, is predicted to increase a performance of the neural network on the main task; and
applying the main task update to the model parameters of the neural network.

17. The method claim 1, wherein determining an auxiliary task update to the model parameters of the neural network comprises:
determining a plurality of auxiliary task gradients, wherein each auxiliary task gradient is a gradient of an auxiliary task objective function with respect to the model parameters of the neural network; and
determining the auxiliary task update as a combination of the plurality of auxiliary task gradients.

18. The method of claim 1, further comprising using the neural network to perform the main task after the neural network has been trained to perform the main task.

19. A system comprising:
one or more computers; and
one or more storage devices communicatively coupled to the one or more computers, wherein the one or more storage devices store instructions that, when executed by the one or more computers, cause the one or more computers to perform operations for training a neural network having a plurality of model parameters to perform a main task, the operations comprising:
determining an auxiliary task update to the model parameters of the neural network that, if applied to the model parameters of the neural network, is predicted to increase a performance of the neural network on an auxiliary task;
determining a decomposition of the auxiliary task update into a plurality of constituent updates that, if applied to the model parameters of the neural network, are each predicted to have a different impact on a performance of the neural network on the main task;
determining a new auxiliary task update to the model parameters of the neural network as a function of the plurality of constituent updates; and
applying the new auxiliary task update to the model parameters of the neural network.

20. One or more non-transitory computer storage media storing instructions that when executed by one or more computers cause the one or more computers to perform operations for training a neural network having a plurality of model parameters to perform a main task, the operations comprising:
determining an auxiliary task update to the model parameters of the neural network that, if applied to the model parameters of the neural network, is predicted to increase a performance of the neural network on an auxiliary task;
determining a decomposition of the auxiliary task update into a plurality of constituent updates that, if applied to the model parameters of the neural network, are each predicted to have a different impact on a performance of the neural network on the main task;
determining a new auxiliary task update to the model parameters of the neural network as a function of the plurality of constituent updates; and
applying the new auxiliary task update to the model parameters of the neural network.
